(19) United States
(12) Patent Application Publication
(10) Pub. No.: US 2020/0211374 A1
(43) Pub. Date: Jul. 2, 2020

(54) SYSTEM, METHOD, AND APPARATUS FOR ANALYZING A TRAFFIC ROAD CONDITION

(71) Applicant: ALIBABA GROUP HOLDING LIMITED, George Town (KY)

(72) Inventors: Yu LIU, Beijing (CN); Jiawei WANG, Hangzhou (CN); Mengjia WANG, Hangzhou (CN); Han WANG, Hangzhou (CN); Zhe ZHU, Hangzhou (CN); Wanli MIN, Hangzhou (CN)

(21) Appl. No.: 16/814,800

(22) Filed: Mar. 10, 2020

Related U.S. Application Data
(63) Continuation of application No. PCT/CN2018/104516, filed on Sep. 7, 2018.

(30) Foreign Application Priority Data
Sep. 11, 2017 (CN) 201710810896.3

(51) Int. Cl. G08G 1/01

(52) U.S. Cl. CPC G08G 1/0133; G08G 1/0145

(57) ABSTRACT

Embodiments of the present disclosure can provide a system, a method and an apparatus for analyzing a traffic road condition. The method can include acquiring attribute information and road traffic information of a traffic network, comprising road intersections and road segments, analyzing the attribute information and the road traffic information to generate road condition parameters, monitoring the traffic road condition of the traffic network based on the generated road condition parameters, and adjusting, in response to a determination that a road condition monitoring result of a road intersection of the traffic network is an unbalanced intersection, a phase signal of a signal light of the unbalanced intersection.

### CROSS-REFERENCE TO RELATED APPLICATION

The present disclosure claims the benefits of priority to International Application No. PCT/CN2018/104516, filed on Sep. 7, 2018, which claims priority to Chinese Patent Application No. 201710810896.3, filed on Sep. 11, 2017, both of which are incorporated herein by reference in their entireties.

### BACKGROUND

With rapid development of economy and continuous improvement of living standards, the number of motor vehicles has increased rapidly, especially private cars, which are continuously swarming into limited urban traffic networks, imposing tremendous pressure to the urban traffic networks, and particularly resulting in a lot of problems to road intersections in the urban traffic networks. A road intersection of two or more roads, where vehicles and pedestrians gather, steer, and evacuate, is the throat of an urban traffic network. If traffic signal control at the road intersection is unreasonable, it is likely that passing vehicles will frequently encounter red lights, resulting in time delay and excessive fuel consumption. At the same time, it will aggravate air pollution and noise pollution, and may even make drivers agitated, thereby resulting in traffic accidents. Therefore, road traffic control at the road intersection appears to be particularly important.

At present, for collecting road condition information of road intersections in a traffic network, conventional data acquisition devices, such as fixed video cameras, coils, and microwaves, are usually dispersed in the traffic network based on actual situation of the road intersections to collect road condition information of each road segment in the traffic network. However, since investment costs and maintenance costs of conventional data acquisition devices are relatively high, the distribution density of these devices in one traffic network is relatively low, resulting in a relatively high data miss rate of the collected road condition information. At the same time, since conventional data acquisition devices, such as fixed coils or video cameras, can only collect road condition information in limited areas, there are quite a few collection blind zones. Some conventional systems are limited in capabilities to analyze the traffic road condition and estimate the changing trend of traffic flow in each road segment of a traffic network based on the road condition information collected by conventional data acquisition devices. In addition, some conventional systems are less accurate in accordingly adjusting the traffic signals of each road segment of the traffic network based on the traffic road condition analysis result and traffic flow trend estimation result, and has certain limitations in analyzing the traffic road condition of each road segment of the traffic network.

### SUMMARY

Embodiments of the present disclosure can provide a system, a method and an apparatus for analyzing a traffic road condition. The method can include acquiring attribute information and road traffic information of a traffic network comprising road intersections and road segments, analyzing the attribute information and the road traffic information to generate road condition parameters, monitoring the traffic road condition of the traffic network based on the generated road condition parameters, and adjusting, in response to a determination that a road condition monitoring result of a road intersection of the traffic network is an unbalanced intersection, a phase signal of a signal light of the unbalanced intersection.

### BRIEF DESCRIPTION OF THE DRAWINGS

FIG. 1 is a schematic diagram of an exemplary system for analyzing a traffic road condition, consistent with some embodiments of the present disclosure.

FIG. 2 is a schematic diagram of an exemplary traffic network.

FIG. 3 is a schematic diagram of an exemplary road intersection.

FIG. 4 is a flowchart of an exemplary method for analyzing a traffic road condition, consistent with some embodiments of the present disclosure.

FIG. 5 is a schematic diagram of an exemplary apparatus for analyzing a traffic road condition, consistent with some embodiments of the present disclosure.

FIG. 6 is a schematic diagram of an exemplary electronic device, consistent with some embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure:

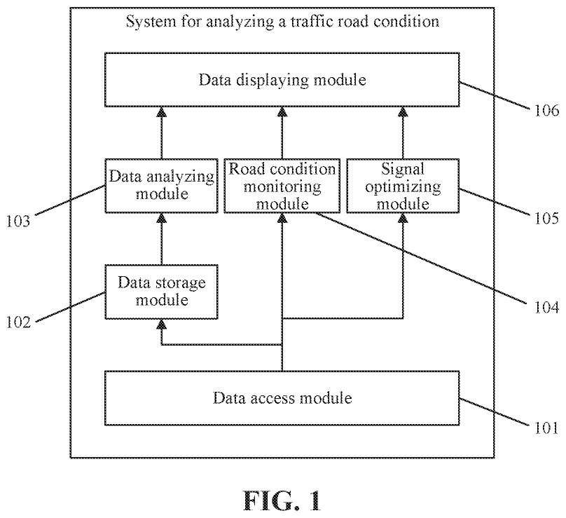

As shown in FIG. 1, an exemplary system for analyzing a traffic road condition according to some embodiments of the present disclosure includes: a data access module 101, a data storage module 102, a data analyzing module 103, a road condition monitoring module 104, a signal optimizing module 105, and a data displaying module 106. The data access module 101 is configured to access attribute information and road traffic information of a traffic network.

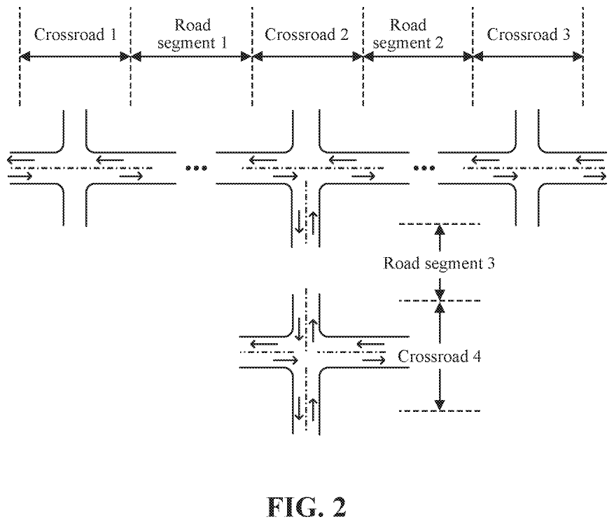

The traffic network is composed of road intersections and road segments. The road intersection refers to an intersection of two or more than two roads, such as common crossroads, T-junctions, junctions of three roads, and roundabouts. The road segment refers to a passable road between road intersections. The traffic network as shown in FIG. 2 is composed of four road intersections (crossroads) and 3 road segments. The traffic network can include one or more road intersections and one or more road segments, or can include merely one or more road intersections, or can include merely one or more road segments.

The attribute information of the traffic network refers to road network topology and a road attribute of the traffic network, and the road traffic information of the traffic network refers to real-time traffic road condition information, such as traffic flow, traffic velocity, and vehicle running track. The traffic network of some embodiments is composed of road intersections and road segments. Therefore, the attribute information and the road traffic information of the traffic network can be specifically divided into attribute information and road traffic information of the road intersection in the traffic network, and attribute information and road traffic information of the road segment in the traffic network.

Specifically, the attribute information of the road intersection can be one or more items of: the name of the city to which the road intersection belongs, an identification code of the city, the name of an entrance road segment, the name of an exit road segment, the name of the road intersection, attributes of the road intersection, a corresponding road node identifier in an electronic map, a sheet designation of the road node, a sheet designation of the entrance road segment, a road segment identifier of the entrance road segment, a sheet designation of the exit road segment, a road segment identifier of the exit road segment, a road direction of the entrance road segment, a road direction of the exit road segment, an entrance angle of the entrance road segment, an exit angle of the exit road segment, and the geographical area where the road intersection is located. The road traffic information of the road intersection can be one or more items of: traffic flow in each traffic stream direction of the road intersection, an actual running velocity on the upstream road segment of each traffic line in each traffic stream direction, an actual running velocity on the downstream road segment of each traffic line in each traffic stream direction, time information corresponding to an actual running velocity, a vehicle running direction corresponding to a traffic line, and a vehicle running track; and the vehicle running direction includes: turning left, turning right, going straight, and turning around.

Similarly, the attribute information of the road segment can be one or more items of information listed below: the name of the city to which the road segment belongs, an identifier code of the city, the name of the road segment, a corresponding road node identifier in an electronic map, a sheet designation of the road node, a sheet designation of the road segment, an identifier of the road segment, a road direction of an entrance road segment, a road direction of an exit road segment, an entrance angle of the entrance road segment, an exit angle of the exit road segment, and the geographical area where the road segment is located. The road traffic information of the road segment can be one or more items of information listed below: traffic flow in each traffic stream direction of the road segment, an actual running velocity on the upstream road segment of each traffic line in each traffic stream direction, an actual running velocity on the downstream road segment of each traffic line in each traffic stream direction, time information corresponding to an actual running velocity, a vehicle running direction corresponding to a traffic line, and a vehicle running track; and the vehicle running direction includes: turning left, turning right, going straight, and turning around.

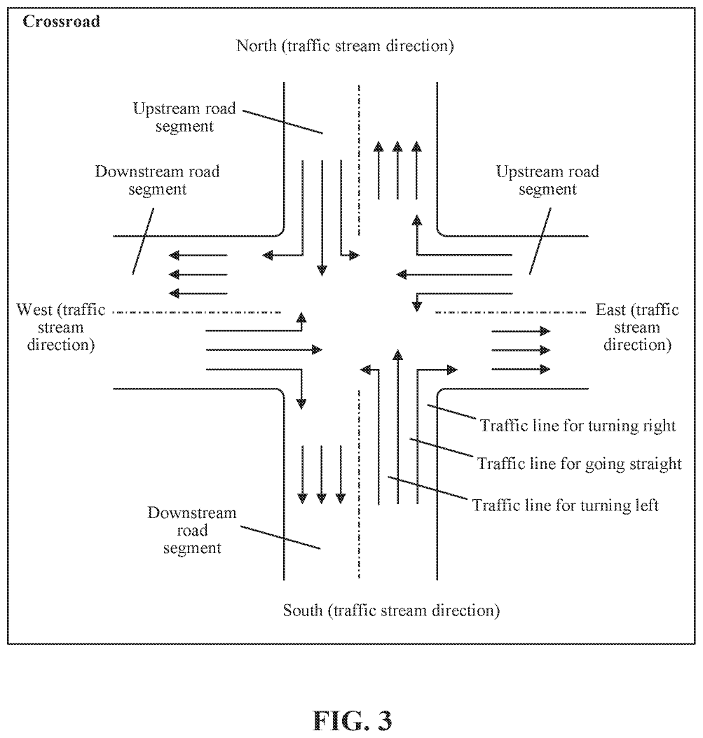

A road intersection (crossroad) as shown in FIG. 3 includes 4 traffic stream directions: east, south, west, and north. An entrance direction of each traffic stream direction can be regarded as the upstream road segment of a current traffic stream direction, and an exit direction opposite to the upstream road segment can be regarded as the downstream road segment of the current traffic stream direction. Further, there are 3 traffic lines in each traffic stream direction. Taking a traffic stream direction “south” as an example, a traffic line in the middle is a traffic line for going straight from an upstream road segment of the traffic stream direction “south” to a downstream road segment; a traffic line on the right side is a traffic line for turning right from the upstream road segment of the traffic stream direction “south” to a downstream road segment of a traffic stream direction “east”; and a traffic line on the left side is a traffic line for turning left from the upstream road segment of the traffic stream direction “south” to a downstream road segment of a traffic stream direction “west.” Similarly, there are 3 traffic lines in each traffic stream direction, and there are 12 traffic lines in total at the crossroad.

In practical applications, terminal devices of many travelers transmit their own geographical location information, moving velocities, and moving directions to a cloud in real time via a mobile Internet. The geographical location information, moving velocities, moving directions, and travel lines can all be used as road traffic information of corresponding road segments or the corresponding road intersection. With the widespread use of mobile terminal devices, collecting the road traffic information is implemented by the above approaches, such that dense time intervals can cover the traffic network in a time dimension, while more dense locations can cover road intersections and road segments in the traffic network in a spatial dimension, thereby achieving collecting the road traffic information of the traffic network without a blind zone in the time dimension and the spatial dimension.

The data storage module 102 is configured to store the attribute information and the road traffic information of the road intersection and the road segment accessed by the data access module 101, and the attribute information and the road traffic information stored in the data storage module 102 are used for providing data basis for data mining and model training by the data analyzing module 103.

In practical applications, in order to more accurately analyze the traffic road condition of the traffic network, the exemplary system for analyzing a traffic road condition can also be implemented in a cloud computing environment. In this case, the data storage module 102 can also store the attribute information and the road traffic information based on a database service provided by a cloud server cluster deployed in the cloud computing environment, e.g., storing the attribute information and the road traffic information through a Relational Database Service (RDS), thereby facilitating implementing access to the attribute information and the road traffic information by the data analyzing module 103 or the road condition monitoring module 104 based on a cloud server node in the cloud server cluster.

The data analyzing module 103 is configured to analyze the attribute information and the road traffic information to generate road condition parameters of the traffic network, i.e., performing data mining based on the attribute information and the road traffic information stored in the data storage module 102.

The road condition parameters include: a queuing length in each traffic stream direction of the road intersection or the road segment, the number of times of vehicle stops in each traffic stream direction of the road intersection and the road segment, transit time in each traffic stream direction of the road intersection and the road segment, and an entrance velocity and an exit velocity in each traffic stream direction of the road intersection and the road segment.

The queuing length in each traffic stream direction of the road intersection refers to a queuing length in each traffic stream direction of the road intersection within a time granularity (such as 10 min). Similarly, the queuing length in each traffic stream direction of the road segment refers to a queuing length in each traffic stream direction of the road segment within a time granularity (such as 10 min). The number of times of vehicle stops in each traffic stream direction of the road intersection is obtained by counting the number of times of vehicle stops of vehicles running through the road intersection in each traffic stream direction within a time granularity, and computing the average number of times of vehicle stops of all vehicles running through the road intersection in each traffic stream direction within the time granularity. The average number of times of vehicle stops is the number of times of vehicle stops in each traffic stream direction of the road intersection.

Similarly, the number of times of vehicle stops in each traffic stream direction of the road segment refers to the average number of times of vehicle stops of all vehicles running through the read segment in each traffic stream direction within the time granularity. The transit time in each traffic stream direction of the road intersection is obtained by taking two fixed points, i.e., an entrance location point and an exit location point, at an entrance and an exit in each traffic stream direction of the road intersection, computing required time of a vehicle running from the entrance location point to the exit location point in each traffic stream direction, and further computing average transit time of all vehicles running from the entrance location point to the exit location point in each traffic stream direction within a time granularity. The average transit time is the transit time in each traffic stream direction of the road intersection. Similarly, the transit time in each traffic stream direction of the road segment refers to average transit time of all vehicles running from the entrance location point to the exit location point in each traffic stream direction of the road segment within a time granularity. The average transit time is the transit time in each traffic stream direction of the road segment. Of the entrance velocity and the exit velocity in each traffic stream direction of the road intersection, the entrance velocity in each traffic stream direction of the road intersection refers to an average entrance velocity of all vehicles entering the road intersection in each traffic stream direction within a time granularity; and the exit velocity in each traffic stream direction of the road intersection refers to an average exit velocity of all vehicles exiting the road intersection in each traffic stream direction within a time granularity.

Similarly, the entrance velocity in each traffic stream direction of the road segment refers to an average entrance velocity of all vehicles entering the road segment in each traffic stream direction within a time granularity; and the exit velocity in each traffic stream direction of the road segment refers to an average exit velocity of all vehicles exiting the road segment in each traffic stream direction within a time granularity.

Further, the data analyzing module 103 can further perform model training based on the attribute information and the road traffic information stored in the data storage module 102, and the road condition parameters obtained by the above data mining, and is specifically configured to train a real-time road condition monitoring model. The road condition monitoring module 104 is configured to perform traffic road condition monitoring based on the real-time road condition monitoring model. In the process of training the real-time road condition monitoring model, after reading the attribute information and the road traffic information stored in the data storage module 102 from the data storage module, the following operations on the attribute information and the road traffic information obtained from the reading are performed: removing noise data in the attribute information or the road traffic information; segmenting the attribute information or the road traffic information in a time dimension; and ranking data segments obtained from the segmenting, selecting data corresponding to the data segments for use as benchmark data, and using the benchmark data as parameters of the real-time road condition monitoring model. For example, time of a day is divided into peak hours and off-peak hours based on time, and actual running velocities in the off-peak hours are ranked in ascending order. For example, 95% quantile point is taken as a smooth-running velocity (benchmark data).

As described above, if the system for analyzing a traffic road condition is implemented in the cloud computing environment, and the data storage module 102 stores the attribute information and the road traffic information based on the relational database service, in which case the data analyzing module 103 can perform the above data mining and model training based on a big data computing service provided by a cloud server cluster deployed in the cloud computing environment.

The road condition monitoring module 104 is configured to perform traffic road condition monitoring on the traffic network based on the road condition parameters to generate a road condition monitoring result of the traffic network.

The road condition monitoring module 104 performs traffic road condition monitoring on the road intersection and the road segment based on the real-time road condition monitoring model obtained by the data analyzing module 103 from offline data training, thereby obtaining the road condition monitoring result of the road intersection and the road segment. When performing traffic road condition monitoring on the road intersection by the real-time road condition monitoring model, an input to the real-time road condition monitoring model is the road condition parameters of the road intersection, and an output from the real-time road condition monitoring model is the road condition monitoring result of the road intersection. Similarly, when performing traffic road condition monitoring on the road segment by the real-time road condition monitoring model, an input to the real-time road condition monitoring model is the road condition parameters of the road segment, and an output from the real-time road condition monitoring model is the road condition monitoring result of the road segment. For example, a smooth running velocity (benchmark data) obtained by the above data analyzing module 103 is used as a computing factor of the real-time road condition monitoring model, and specifically, the actual running velocity in each traffic stream direction of the road intersection or the road velocity is compared with the smooth running velocity. If the actual running velocity is less than 50% of the smooth running velocity, then an abnormal situation alarm is given, indicating that the traffic stream direction of the road intersection or the road segment is blocked, such that the vehicles run slowly.

In some embodiments, overall traffic road condition and dispatching capacity of the road intersection can be further monitored by the real-time road condition monitoring model, and specifically, an capacity to adjust a traffic supply (road capacity) and demand (real-time traffic flow) relationship in each traffic stream direction of the road intersection by a traffic control signal is measured by computing an unbalance index of the road intersection. The higher the unbalance index of the road intersection is, the weaker the capacity of the road intersection to adjust traffic supply and demand is. Thus, due to unreasonable green time distribution of the road intersection within a signal cycle, there is a situation that vehicle queues at entrances in some traffic stream directions are long, while the empty release rate during green time in other traffic stream directions is high. Conversely, the lower the unbalance index of the road intersection is, the stronger the capacity of the road intersection to adjust traffic supply and demand is. Thus, green time distribution of the road intersection within a current signal cycle is reasonable.

When monitoring unbalance situation of overall traffic road condition of the road intersection by the real-time road condition monitoring model, specifically, the unbalance situation of the overall traffic road condition of the road intersection is determined based on the unbalance index of the road intersection. If the unbalance index of the road intersection exceeds a preset unbalance threshold, then the road intersection is determined as an unbalanced intersection of unbalanced traffic road condition, and in this case, the road condition monitoring result outputted by the real-time road condition monitoring model is that: the road intersection is an unbalanced intersection; and if the unbalance index does not exceed the preset unbalance threshold, then the road intersection is determined as a normal intersection of normal traffic road condition, and in this case, the road condition monitoring result outputted by the real-time road condition monitoring model is that: the road intersection is the normal intersection.

The unbalance index refers to a sum of unbalance indexes of traffic lines in all traffic stream directions of the road intersection, and an unbalance index of any traffic line refers to a product of a difference between a ratio of an actual running velocity in the upstream of the traffic line to a free running velocity in the upstream of the traffic line and a ratio of an actual running velocity in the downstream of the traffic line to a free running velocity in the downstream of the traffic line and a weight of the traffic line in traffic flow of the road intersection. Specifically, the unbalance index of the road intersection can be determined, for example, by computing a difference between an entrance direction and an exit direction of a traffic line i of the road intersection at a moment t and computing an unbalance index of the road intersection at the moment t.

The difference (diff_{i,t}) between an entrance direction and an exit direction of a traffic line i of the road intersection at a moment t can be determined based on the following formula:

$${diff}_{i , t} = {w}_{i} ( \frac{{v\_up}_{i , t}}{{fv\_up}_{i , t}} - \frac{{v\_down}_{i , t}}{{fv\_down}_{i , t}} )$$

where v_up_{i,t} is an actual running velocity in the upstream of the traffic line i of the road intersection at the moment t, fv_up_{i,t} is a free running velocity in the upstream of the traffic line i of the road intersection at the moment t (running velocity of a vehicle running through the upstream of the traffic line i in an unblocked state/normal situation), v_down_{i,t} is an actual running velocity in the downstream of the traffic line i of the road intersection at the moment t, fv_down_{i,t} is a free running velocity in the downstream of the traffic line i of the road intersection at the moment t (running velocity of a vehicle running through the downstream of the traffic line i in an unblocked state/normal situation), and wᵢ is a weight of the traffic line i in all traffic lines of the road intersection based on the traffic flow.

The unbalance index of the road intersection at the moment t (U_indexₜ) can be determined based on the following formula:

$${U\_index}_{t} = \vert {\sum }_{i = 1}^{n} {signal}_{i} * {diff}_{i , t} \vert$$

wherein signalᵢ is whether each traffic line of the road intersection is asynchronous or synchronous in signal cycle setting, is 1 if each traffic line of the road intersection is synchronous, and is −1 if each traffic line of the road intersection is asynchronous.

The signal optimizing module 105 is configured to adjust a phase signal (traffic control signal) of a signal light of the road intersection based on attribute information and road condition parameters of the road intersection to generate a phase signal adjustment scheme for the signal light of the road intersection.

In some embodiments, signal optimizing module 105 can run independently, for example, optimizing the phase signal of the signal light of the road intersection by signal optimizing module 105, thereby obtaining the phase signal adjustment scheme for the signal light of the road intersection. Assuming that a current phase signal of at least one road intersection in the traffic network is very reasonably provided without the need for adjustment, then when optimizing the phase signal of the signal light of the road intersection by the signal optimizing module 105, the obtained phase signal adjustment scheme should be empty, i.e., it is not necessary to adjust the phase signal of the signal light of the road intersection. In addition, the signal optimizing module 105 can further cooperate with the road condition monitoring module 104, and running of the signal optimizing module 105 depends on a running result of the road condition monitoring module 104. If the road condition monitoring module 104 monitors by the real-time road condition monitoring model that the overall traffic road condition of the road intersection is in an unbalanced state, then the signal optimizing module 105 is run for the road intersection, namely: the signal optimizing module 105 is run for the road intersection with the traffic road condition being in the unbalanced state (unbalanced intersection) to optimize the traffic control signal of the unbalanced intersection.

In some embodiments, the phase signal of the signal light of the road intersection is adjusted by the phase signal adjusting model, an input to the phase signal adjusting model can be the attribute information of the road intersection, the road traffic information, or a constraint condition, an output from the phase signal adjusting model can be a green time ratio of each phase signal of the signal light of the road intersection, and the phase signal adjustment scheme for the signal light of the road intersection is determined based on the green time ratio of each phase signal. In addition, the output from the phase signal adjusting model can also be an adjustment amount of green time of the phase signal. Specifically, the phase signal adjusting model optimizes a green time ratio of a signal light cycle by adjusting the green time of the phase signal based on unbalance information of a traffic line in each traffic stream direction of the road intersection, thereby achieving the purpose of enhancing the traffic efficiency of the road intersection.

Specifically, a target function and a constraint function of the phase signal adjusting model are illustrated with parameters as follows.

A function relationship between green light adjustment time (gtimeᵢ) of the traffic line i in each traffic stream direction of the road intersection and a difference (diff_{i,t}) between the entrance direction and the exit direction of the traffic line i at the moment t can be determined based on the following:

$${gtime}_{i} = f ( {diff}_{i} , t )$$

$${diff}_{i , t} = {w}_{i} ( \frac{{v\_up}_{i , t}}{{fv\_up}_{i , t}} - \frac{{v\_down}_{i , t}}{{fv\_down}_{i , t}} )$$

$${gtime}_{i} = f ( {diff}_{i} , t ) = {β}_{i}^{t} * {diff}_{i}$$

wherein gtimeᵢ is the green light adjustment time of the traffic line i, and βᵢ^{t} is a phase adjustment coefficient.

To reduce the overall index of the road intersection, the exemplary system adjusts green time in each stage of the phase signal, and minimizes a sum of squares of an error between actual phase adjustment time and theoretical phase adjustment time of an i-th traffic line (n traffic lines in total) within the phase signal cycle while maintaining a constant phase signal cycle.

One phase signal cycle includes m signal light stages. Actual phase adjustment time of each traffic line is constituted by summing total adjustment time of mᵢ signal light stages, and then actual phase adjustment time corresponding to a minimum sum of squares of an error between theoretical phase adjustment time and actual phase adjustment time of each phase signal of the signal light of the road intersection is determined based on the theoretical phase adjustment time of each traffic line in each traffic stream direction of the road intersection.

The target function of the phase signal adjusting model is:

$$min {\sum }_{i = 1}^{n} {{w}_{i}^{2} [ f ( {diff}_{i} ) - {\sum }_{j = 1}^{{m}_{i}} {t}_{j} ]}^{2}$$

wherein n is the number of traffic lines in a traffic stream direction of the road intersection, t is a preset time interval (e.g., 10 min or 30 min), wᵢ^{t} is a ratio of traffic flow of a current traffic line within 10 min to total traffic flow in the traffic stream direction, f(diffᵢ) is theoretical phase adjustment time of the current traffic line within the preset time interval, and Σⱼ₌₁^{m}^{ᵢ} tⱼ is the actual phase adjustment time of each phase signal within 10 min.

In addition, the target function is configured to meet the following constraint condition: a sum of the theoretical phase adjustment time of each phase signal of the traffic line within a single phase cycle is equal to 0, illustrated based on the following formula:

$${\sum }_{j = 1}^{m} {δ}_{j}^{t} = 0$$

wherein m is the number of phase signals within a complete phase cycle (phase signal stages).

In practical applications, a function relationship between the actual phase adjustment time and an unbalance degree can be learned using artificial intelligence and a cloud computing platform of big data, and the phase adjustment model is trained using a phase adjustment coefficient of the target function to obtain a more accurate phase adjustment coefficient, such as a phase adjustment coefficient for different time intervals (peak hours, off-peak hours), a phase adjustment coefficient for different time intervals (working days, non-working days), or a phase adjustment coefficient for different intersections in the traffic network. On this basis, the obtained actual phase adjustment time is more accurately computed using the target function of the current phase adjustment coefficient.

As described above, if the system for analyzing a traffic road condition is implemented in the cloud computing environment, and the data storage module 102 stores the attribute information and the road traffic information based on the relational database service, the data analyzing module 103 can perform the above data mining and model training based on a big data computing service provided by a cloud server cluster deployed in the cloud computing environment. In this case, the road condition monitoring module 104 or the signal optimizing module 105 can be deployed on one or more cloud server nodes of the cloud server cluster.

The data displaying module 106 can be configured not only to visually display the road condition monitoring result of the traffic network generated by the road condition monitoring module 104, but also to visually display the phase signal adjustment scheme for the signal light of the road intersection generated by the signal optimizing module 105, and can be further configured to visually display the road condition parameters of the traffic network generated by the data analyzing module 103.

In conclusion, the system for analyzing a traffic road condition provided by the present disclosure, when monitoring and analyzing the traffic road condition of the traffic network, achieves traffic road condition monitoring on road intersections and road segments in the traffic network through synergic actions of the data access module, the data analyzing module and the road condition monitoring module; and analyzes overall traffic road condition state of the road intersection, and optimizes and adjusts a phase signal of a traffic light of the road intersection to enhance overall traffic capacity of the road intersection, such that overall traffic road condition of the road intersection is more reasonable, and the traffic road condition of the road intersection is more accurately analyzed in more detail. The system performs traffic road condition monitoring on the road intersection and the road segment in the traffic network, and optimizes and improves the overall traffic road condition of the road intersection, such that the traffic road condition of the traffic network is more comprehensively analyzed.

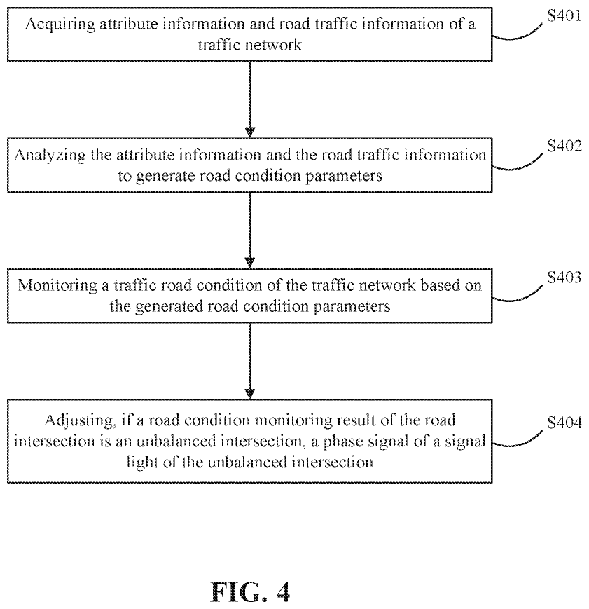

Referring to FIG. 4, a flowchart of an exemplary method for analyzing a traffic road condition is illustrated. The method can include the following steps.

In step S401, attribute information and road traffic information of a traffic network are acquired. The traffic network includes road intersections and road segments.

In step S402, the attribute information and the road traffic information are analyzed to generate road condition parameters.

In step S403, A traffic road condition of the traffic network is monitored based on the generated road condition parameters.

In step S404, adjusting, if a road condition monitoring result of the road intersection is an unbalanced intersection, a phase signal of a signal light of the unbalanced intersection.

In some embodiments, after the attribute information and road traffic information of a traffic network are acquired, the attribute information and the road traffic information of the traffic network are stored, a real-time road condition monitoring model is trained based on the attribute information and the road traffic information, the traffic road condition of the traffic network is monitored based on the real-time road condition monitoring model. An input to the real-time road condition monitoring model includes the road condition parameters of the traffic network. An output from the real-time road condition monitoring model includes the road condition monitoring result of the traffic network.

In some embodiments, after the attribute information and the road traffic information of the traffic network are stored, and before the real-time road condition monitoring model is trained based on the attribute information and the road traffic information, noise data in the attribute information or the road traffic information are removed, the attribute information or the road traffic information in a time dimension are segmented, and segments obtained from the segmenting are ranked, and data corresponding to the data segments is selected as benchmark data. The benchmark data is used as parameters of the real-time road condition monitoring model.

In some embodiments, adjusting the phase signal of a signal light of the unbalanced intersection is implemented based on a phase signal adjusting model. An input to the phase signal adjusting model includes the attribute information of the road intersection, the road traffic information, or a constraint condition. An output from the phase signal adjusting model includes a green time ratio of each phase signal of the signal light of the road intersection.

In some embodiments, the road condition monitoring result of the road intersection outputted by the real-time road condition monitoring model includes: an unbalanced intersection with an unbalanced traffic road condition and a normal intersection with a normal traffic road condition. The real-time road condition monitoring model determines the unbalanced intersection and the normal intersection based on an unbalance index of the road intersection, i.e., determines the road intersection as an unbalanced intersection if the unbalance index exceeds a preset unbalance threshold, and determines the road intersection as a normal intersection if the unbalance index does not exceed the preset unbalance threshold. The unbalance index refers to a sum of unbalance indexes of traffic lines in all traffic stream directions of the road intersection, and an unbalance index of any traffic line refers to a product of a difference between a ratio of an actual running velocity in the upstream of the traffic line to a free running velocity in the upstream of the traffic line and a ratio of an actual running velocity in the downstream of the traffic line to a free running velocity in the downstream of the traffic line and a weight of the traffic line in traffic flow of the road intersection.

In some embodiments, the method for analyzing a traffic road condition includes: displaying the road condition monitoring result of the traffic network, the phase signal adjustment scheme for the signal light of the road intersection, or the road condition parameters of the traffic network.

In some embodiments, the method is implemented based on a cloud computing environment, at least one of monitoring the traffic road condition of the traffic network based on the generated road condition parameters or adjusting a phase signal of a signal light of the unbalanced intersection is implemented based on a cloud server cluster deployed in the cloud computing environment and implemented based on a cloud server node of the cloud server cluster. Storing the attribute information and the road traffic information of the traffic network can include storing the attribute information, the road traffic information, or the road condition parameters of the traffic network based on a database service provided by the cloud server cluster. Analyzing the attribute information and the road traffic information is implemented based on a cloud computing service provided by the cloud server cluster.

In some embodiments, the attribute information of the road intersection includes at least one of the following items: the name of the city to which the road intersection belongs, an identification code of the city, the name of an entrance road segment, the name of an exit road segment, the name of the road intersection, attributes of the road intersection, a corresponding road node identifier in an electronic map, a sheet designation of the road node, a sheet designation of the entrance road segment, a road segment identifier of the entrance road segment, a sheet designation of the exit road segment, a road segment identifier of the exit road segment, a road direction of the entrance road segment, a road direction of the exit road segment, an entrance angle of the entrance road segment, an exit angle of the exit road segment, and the geographical area where the road intersection is located.

In some embodiments, attribute information of the road segment includes at least one of the following items: the name of the city to which the road segment belongs, an identifier code of the city, the name of the road segment, a corresponding road node identifier in an electronic map, a sheet designation of the road node, a sheet designation of the road segment, an identifier of the road segment, a road direction of an entrance road segment, a road direction of an exit road segment, an entrance angle of the entrance road segment, an exit angle of the exit road segment, and the geographical area where the road segment is located.

In some embodiments, road traffic information of the road intersection or the road segment includes at least one of the following items: traffic flow in each traffic stream direction of the road intersection or the road segment, an actual running velocity on the upstream road segment of each traffic line in each traffic stream direction, an actual running velocity on the downstream road segment of each traffic line in each traffic stream direction, time information corresponding to an actual running velocity, a vehicle running direction corresponding to a traffic line, and a vehicle running track. The vehicle running direction includes: turning left, turning right, going straight, and turning around.

In some embodiments, the road condition parameters include at least one of the following items: a queuing length in each traffic stream direction of the road intersection or the road segment, the number of times of vehicle stops in each traffic stream direction of the road intersection or the road segment, transit time in each traffic stream direction of the road intersection or the road segment, and an entrance velocity and an exit velocity in each traffic stream direction of the road intersection or the road segment.

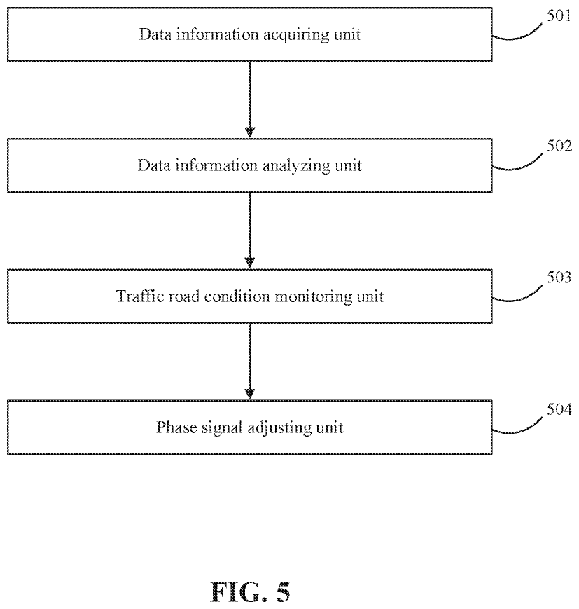

Referring to FIG. 5, a schematic diagram of some embodiments of an apparatus for analyzing a traffic road condition provided by the present disclosure is shown. The apparatus can include a data information acquiring unit 501, a data information analyzing unit 502, a traffic road condition monitoring unit 503, and a phase signal adjusting unit 504.

Data information acquiring unit 501 is configured to acquire attribute information and road traffic information of a traffic network. The traffic network includes road intersections and road segments.

Data information analyzing unit 502 is configured to analyze the attribute information and the road traffic information to generate road condition parameters.

Traffic road condition monitoring unit 503 is configured to monitor a traffic road condition of the traffic network based on the generated road condition parameters.

Phase signal adjusting unit 504 is configured to adjust a phase signal of a signal light of the unbalanced intersection if a road condition monitoring result of the road intersection is an unbalanced intersection.

In some embodiments, the apparatus for analyzing a traffic road condition further includes a data information storing unit and a model training unit. The data information storing unit is configured to store the attribute information and the road traffic information of the traffic network. The model training unit is configured to train a real-time road condition monitoring model based on the attribute information and the road traffic information.

Accordingly, traffic road condition monitoring unit 503 monitors the traffic road condition of the traffic network based on the real-time road condition monitoring model. An input to the real-time road condition monitoring model includes the road condition parameters of the traffic network, and an output from the real-time road condition monitoring model includes the road condition monitoring result of the traffic network.

In some embodiments, the apparatus for analyzing a traffic road condition includes a noise data removing unit, a segmenting unit, and a rank extracting unit. The noise data removing unit is configured to remove noise data in the attribute information or the road traffic information. The segmenting unit is configured to segment the attribute information or the road traffic information in a time dimension. The rank extracting unit is configured to rank data segments obtained from the segmenting, and select data corresponding to the data segments as benchmark data. The benchmark data is used as parameters of the real-time road condition monitoring model.

In some embodiments, phase signal adjusting unit 504 is implemented based on a phase signal adjusting model. An input to the phase signal adjusting model includes the attribute information of the road intersection, the road traffic information, or a constraint condition. An output from the phase signal adjusting model includes a green time ratio of each phase signal of the signal light of the road intersection.

In some embodiments, the road condition monitoring result of the road intersection outputted by the real-time road condition monitoring model includes: an unbalanced intersection with an unbalanced traffic road condition and a normal intersection with a normal traffic road condition. The real-time road condition monitoring model determines the unbalanced intersection and the normal intersection based on an unbalance index of the road intersection. For example, the model determines the road intersection as an unbalanced intersection if the unbalance index exceeds a preset unbalance threshold, and determines the road intersection as a normal intersection if the unbalance index does not exceed the preset unbalance threshold. The unbalance index refers to a sum of unbalance indexes of traffic lines in all traffic stream directions of the road intersection, and an unbalance index of any traffic line refers to a product of a difference between a ratio of an actual running velocity in the upstream of the traffic line to a free running velocity in the upstream of the traffic line and a ratio of an actual running velocity in the downstream of the traffic line to a free running velocity in the downstream of the traffic line and a weight of the traffic line in traffic flow of the road intersection.

In some embodiments, the apparatus for analyzing a traffic road condition further includes a displaying unit. The displaying unit is configured to display the road condition monitoring result of the traffic network, the phase signal adjustment scheme for the signal light of the road intersection, or the road condition parameters of the traffic network.

In some embodiments, the apparatus for analyzing a traffic road condition is implemented in a cloud computing environment. At least one of traffic road condition monitoring unit 503 or phase signal adjusting unit 504 is implemented based on a cloud server cluster deployed in the cloud computing environment, and at least one of traffic road condition monitoring unit 503 or phase signal adjusting unit 504 is deployed on a cloud server node of the cloud server cluster. The data information storing unit stores the attribute information, the road traffic information, or the road condition parameters of the traffic network based on a database service provided by the cloud server cluster. The data information analyzing unit 502 is implemented based on a cloud computing service provided by the cloud server cluster.

In some embodiments, the attribute information of the road intersection includes at least one of the following items: the name of the city to which the road intersection belongs, an identification code of the city, the name of an entrance road segment, the name of an exit road segment, the name of the road intersection, attributes of the road intersection, a corresponding road node identifier in an electronic map, a sheet designation of the road node, a sheet designation of the entrance road segment, a road segment identifier of the entrance road segment, a sheet designation of the exit road segment, a road segment identifier of the exit road segment, a road direction of the entrance road segment, a road direction of the exit road segment, an entrance angle of the entrance road segment, an exit angle of the exit road segment, and the geographical area where the road intersection is located.

In some embodiments, attribute information of the road segment includes at least one of the following items: the name of the city to which the road segment belongs, an identifier code of the city, the name of the road segment, a corresponding road node identifier in an electronic map, a sheet designation of the road node, a sheet designation of the road segment, an identifier of the road segment, a road direction of an entrance road segment, a road direction of an exit road segment, an entrance angle of the entrance road segment, an exit angle of the exit road segment, and the geographical area where the road segment is located.

In some embodiments, road traffic information of the road intersection or the road segment includes at least one of the following items: traffic flow in each traffic stream direction of the road intersection or the road segment, an actual running velocity on the upstream road segment of each traffic line in each traffic stream direction, an actual running velocity on the downstream road segment of each traffic line in each traffic stream direction, time information corresponding to an actual running velocity, a vehicle running direction corresponding to a traffic line, and a vehicle running track; and the vehicle running direction includes: turning left, turning right, going straight, and turning around.

In some embodiments, the road condition parameters include at least one of the following items: a queuing length in each traffic stream direction of the road intersection or the road segment, the number of times of vehicle stops in each traffic stream direction of the road intersection or the road segment, transit time in each traffic stream direction of the road intersection or the road segment, and an entrance velocity and an exit velocity in each traffic stream direction of the road intersection or the road segment.

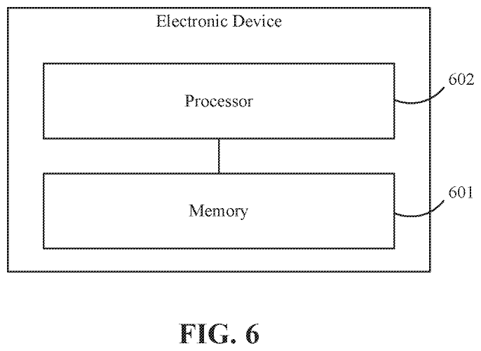

The present disclosure further provides an electronic device for implementing the method for analyzing a traffic road condition. Referring to FIG. 6, a schematic diagram of an exemplary electronic device, consistent with some embodiments of the present disclosure, is shown.

The electronic device includes a memory 601 and a processor 602.

Memory 601 is configured to store computer executable instructions, and processor 602 is configured to execute the computer executable instructions to cause the electronic device to perform acquiring attribute information and road traffic information of a traffic network, the traffic network comprising road intersections and road segments; analyzing the attribute information and the road traffic information to generate road condition parameters; monitoring the traffic road condition of the traffic network based on the generated road condition parameters; and adjusting, in response to a determination that a road condition monitoring result of a road intersection of the traffic network is an unbalanced intersection, a phase signal of a signal light of the unbalanced intersection.

In some embodiments, after acquiring the attribute information and the road traffic information of the traffic network, processor 602 is configured to execute the following computer executable instructions to further perform: storing the attribute information and the road traffic information of the traffic network; and training a real-time road condition monitoring model based on the attribute information and the road traffic information. Monitoring the traffic road condition of the traffic network based on the generated road condition parameters comprises monitoring the traffic road condition of the traffic network based on the real-time road condition monitoring model, an input to the real-time road condition monitoring model comprising the road condition parameters of the traffic network, and an output from the real-time road condition monitoring model comprising the road condition monitoring result of the traffic network.

In some embodiments, after storing the attribute information and the road traffic information of the traffic network, and before training the real-time road condition monitoring model based on the attribute information and the road traffic information, processor 602 is configured to execute the following computer executable instructions to further perform: removing noise data in the attribute information or the road traffic information; segmenting the attribute information or the road traffic information in a time dimension; and ranking data segments obtained from the segmenting, and selecting data corresponding to the data segments as benchmark data. The benchmark data is used as parameters of the real-time road condition monitoring model.

In some embodiments, adjusting the phase signal of the signal light of the unbalanced intersection is implemented based on a phase signal adjusting model, an input to the phase signal adjusting model comprises at least one of attribute information of the road intersection, the road traffic information, or a constraint condition, and an output from the phase signal adjusting model comprises a green time ratio of each phase signal of the signal light of the road intersection.

In some embodiments, the road condition monitoring result of the road intersection outputted by the real-time road condition monitoring model includes: an unbalanced intersection with an unbalanced traffic road condition and a normal intersection with a normal traffic road condition.

The real-time road condition monitoring model determines the unbalanced intersection and the normal intersection based on an unbalance index of the road intersection, for example, the model determines the road intersection as an unbalanced intersection if the unbalance index exceeds a preset unbalance threshold, and determines the road intersection as a normal intersection if the unbalance index does not exceed the preset unbalance threshold. The unbalance index refers to a sum of unbalance indexes of traffic lines in all traffic stream directions of the road intersection, and an unbalance index of any traffic line refers to a product of a difference between a ratio of an actual running velocity in the upstream of the traffic line to a free running velocity in the upstream of the traffic line and a ratio of an actual running velocity in the downstream of the traffic line to a free running velocity in the downstream of the traffic line and a weight of the traffic line in traffic flow of the road intersection.

In some embodiments, processor 602 is configured to execute the following computer executable instruction to further perform: displaying the road condition monitoring result of the traffic network, the phase signal adjustment scheme for the signal light of the road intersection, or the road condition parameters of the traffic network.

In some embodiments, the computer executable instruction is implemented based on a cloud computing environment, at least one of monitoring a traffic road condition monitoring of the traffic network based on the generated road condition parameters or adjusting a phase signal of a signal light of the unbalanced intersection is implemented based on a cloud server cluster deployed in the cloud computing environment, and is implemented based on a cloud server node of the cloud server cluster. Storing the attribute information and the road traffic information of the traffic network comprises storing the attribute information, the road traffic information, or the road condition parameters of the traffic network based on a database service provided by the cloud server cluster. Analyzing the attribute information and the road traffic information is implemented based on a cloud computing service provided by the cloud server cluster.

In some embodiments, the attribute information of the road intersection includes at least one of the following items: the name of the city to which the road intersection belongs, an identification code of the city, the name of an entrance road segment, the name of an exit road segment, the name of the road intersection, attributes of the road intersection, a corresponding road node identifier in an electronic map, a sheet designation of the road node, a sheet designation of the entrance road segment, a road segment identifier of the entrance road segment, a sheet designation of the exit road segment, a road segment identifier of the exit road segment, a road direction of the entrance road segment, a road direction of the exit road segment, an entrance angle of the entrance road segment, an exit angle of the exit road segment, and the geographical area where the road intersection is located.

In some embodiments, attribute information of the road segment includes at least one of the following items: the name of the city to which the road segment belongs, an identifier code of the city, the name of the road segment, a corresponding road node identifier in an electronic map, a sheet designation of the road node, a sheet designation of the road segment, an identifier of the road segment, a road direction of an entrance road segment, a road direction of an exit road segment, an entrance angle of the entrance road segment, an exit angle of the exit road segment, and the geographical area where the road segment is located.

In some embodiments, road traffic information of the road intersection or the road segment includes at least one of the following items: traffic flow in each traffic stream direction of the road intersection or the road segment, an actual running velocity on the upstream road segment of each traffic line in each traffic stream direction, an actual running velocity on the downstream road segment of each traffic line in each traffic stream direction, time information corresponding to an actual running velocity, a vehicle running direction corresponding to a traffic line, and a vehicle running track. The vehicle running direction includes turning left, turning right, going straight, and turning around.

In some embodiments, the road condition parameters include at least one of the following items: a queuing length in each traffic stream direction of the road intersection or the road segment, the number of times of vehicle stops in each traffic stream direction of the road intersection or the road segment, transit time in each traffic stream direction of the road intersection or the road segment, and an entrance velocity and an exit velocity in each traffic stream direction of the road intersection or the road segment.

In a typical configuration, a computing device includes one or more processors (CPU), an input/output interface, a network interface, and an internal memory.

The internal memory can include forms, such as a volatile memory, a random access memory (RAM), or a nonvolatile memory, e.g., a read only memory (ROM) or a flash RAM, in a computer readable medium. The internal memory is an example of the computer readable medium.

The computer readable medium includes permanent/non-permanent media and removable/non-removable media that can achieve information storage by any method or technology. The information can be a computer readable instruction, a data structure, a program module, or other data. Examples of the computer storage medium include, but are not limited to, a phase-change random access memory (PRAM), a static random access memory (SRAM), a dynamic random access memory (DRAM), a random access memory (RAM) of other type, a read only memory (ROM), an electrically erasable programmable read only memory (EEPROM), a flash RAM or other internal memory technology, a compact disc read only memory (CD-ROM), a digital versatile disc (DVD) or other optical storage, a magnetic cassette tape, a magnetic tape or magnetic disk storage or other magnetic storage device, or any other non-transmission medium, which can be configured to store information that can be accessed by the computing device. As defined herein, the computer readable medium excludes transitory media, e.g., a modulated data signal or carrier wave.

It should be appreciated by those skilled in the art that the embodiments of the present disclosure can be provided as a method, system, or computer program product. Accordingly, the present disclosure can be implemented as a completely hardware embodiment, a completely software embodiment, or some embodiments which is a combination of software and hardware. Further, the present disclosure can take the form of one or more computer program products implemented on a computer usable storage medium (including but not limited to a disk storage, a CD-ROM, an optical memory, etc.) containing computer usable program codes.

The embodiments of the present disclosure are described with reference to flowcharts or block diagrams of the method, the terminal device (system) and the computer program product. It should be understood that a computer program instruction can be used to implement each process and/or block in the flowcharts and/or block diagrams and combinations of processes and/or blocks in the flowcharts and/or block diagrams. The computer program instructions can be provided to a general-purpose computer, a special-purpose computer, an embedded processor or a processor of another programmable data processing terminal device to generate a machine, such that the computer or the processor of another programmable data processing terminal device executes an instruction to generate an apparatus configured to implement functions designated in one or more processes in a flowchart and/or one or more blocks in a block diagram.

The computer program instructions can also be stored in a computer readable storage that can guide the computer or another programmable data processing terminal device to work in a specific manner, such that the instruction stored in the computer readable storage generates an article of manufacture including an instruction apparatus, and the instruction apparatus implements functions designated by one or more processes in a flowchart or one or more blocks in a block diagram.

The computer program instructions can also be loaded into the computer or another programmable data processing terminal device, such that a series of operation steps are executed on the computer or another programmable terminal device to generate a computer implemented processing, and therefore, the instruction executed in the computer or another programmable terminal device provides steps for implementing functions designated in one or more processes in a flowchart and/or one or more blocks in a block diagram.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the embodiments disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the database may include A, or B, or C, or A and B, or A and C, or B and C, or A and B and C.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

Finally, it should be further noted that in this text, the relation terms such as “first” and “second” are merely used to distinguish one entity or operation from another entity or operation, and do not require or imply that the entities or operations have this actual relation or order. Moreover, the terms “include,” “comprise” or any other variations thereof are intended to cover non-exclusive inclusion, so that a process, method, article or terminal device including a series of elements not only includes the elements, but also includes other elements not clearly listed, or further includes elements inherent to the process, method, article or terminal device. In the absence of more limitations, an element defined by “including a/an . . . ” does not exclude that the process, method, article or terminal device including the element further has other identical elements.

1-10. (canceled)

11. A method for analyzing a traffic road condition, comprising:
acquiring attribute information and road traffic information of a traffic network comprising road intersections and road segments;
analyzing the attribute information and the road traffic information to generate road condition parameters;
monitoring the traffic road condition of the traffic network based on the generated road condition parameters; and
adjusting, in response to a determination that a road condition monitoring result of a road intersection of the traffic network is an unbalanced intersection, a phase signal of a signal light of the unbalanced intersection.

12. The method according to claim 11, wherein after acquiring the attribute information and the road traffic information of the traffic network, the method further comprising:
storing the attribute information and the road traffic information of the traffic network; and
training a real-time road condition monitoring model based on the attribute information and the road traffic information;
wherein monitoring the traffic road condition of the traffic network based on the generated road condition parameters comprises monitoring the traffic road condition of the traffic network based on the real-time road condition monitoring model, an input to the real-time road condition monitoring model comprising the road condition parameters of the traffic network, and an output from the real-time road condition monitoring model comprising the road condition monitoring result of the traffic network.

13. The method according to claim 12, wherein after storing the attribute information and the road traffic information of the traffic network, and before training the real-time road condition monitoring model based on the attribute information and the road traffic information, the method further comprising:
removing noise data in at least one of the attribute information or the road traffic information;
segmenting at least one of the attribute information or the road traffic information in a time dimension; and
ranking data segments obtained from the segmenting, and selecting data corresponding to the data segments as benchmark data, the benchmark data being used as parameters of the real-time road condition monitoring model.

14. The method according to claim 11, wherein adjusting the phase signal of the signal light of the unbalanced intersection is implemented based on a phase signal adjusting model, an input to the phase signal adjusting model comprises at least one of attribute information of the road intersection, the road traffic information, or a constraint condition, and an output from the phase signal adjusting model comprises a green time ratio of each phase signal of the signal light of the road intersection.

15. The method according to claim 11, further comprising:
displaying at least one of the road condition monitoring result of the traffic network, a phase signal adjustment scheme for the signal light of the road intersection, or the road condition parameters of the traffic network.

16. The method according to claim 12, wherein at least one of monitoring the traffic road condition of the traffic network based on the generated road condition parameters or adjusting the phase signal of the signal light of the unbalanced intersection is implemented based on a cloud server cluster deployed in the cloud computing environment and implemented based on a cloud server node of the cloud server cluster,
storing the attribute information and the road traffic information of the traffic network comprises storing at least one of the attribute information, the road traffic information, or the road condition parameters of the traffic network based on a database service provided by the cloud server cluster, and
analyzing the attribute information and the road traffic information is implemented based on a cloud computing service provided by the cloud server cluster.

17. An apparatus for analyzing a traffic road condition, comprising:
a memory storing a set of instructions; and
one or more processors configured to execute the set of instruction to cause the apparatus to perform:
acquiring attribute information and road traffic information of a traffic network comprising road intersections and road segments,
analyzing the attribute information and the road traffic information to generate road condition parameters,
monitoring the traffic road condition of the traffic network based on the generated road condition parameters, and
adjusting, in response to a determination that a road condition monitoring result of a road intersection of the traffic network is an unbalanced intersection, a phase signal of a signal light of the unbalanced intersection.

18. The apparatus of claim 17, wherein after acquiring the attribute information and the road traffic information of the traffic network, the one or more processors are configured to execute the set of instruction to cause the apparatus to further perform:
storing the attribute information and the road traffic information of the traffic network, and
training a real-time road condition monitoring model based on the attribute information and the road traffic information,
wherein monitoring the traffic road condition of the traffic network based on the generated road condition parameters comprises monitoring the traffic road condition of the traffic network based on the real-time road condition monitoring model, an input to the real-time road condition monitoring model comprising the road condition parameters of the traffic network, and an output from the real-time road condition monitoring model comprising the road condition monitoring result of the traffic network.

19. The apparatus of claim 18, wherein after storing the attribute information and the road traffic information of the traffic network, and before training the real-time road condition monitoring model based on the attribute information and the road traffic information, the one or more processors are configured to execute the set of instruction to cause the apparatus to further perform:
removing noise data in at least one of the attribute information or the road traffic information,
segmenting at least one of the attribute information or the road traffic information in a time dimension, and
ranking data segments obtained from the segmenting, and selecting data corresponding to the data segments as benchmark data, the benchmark data being used as parameters of the real-time road condition monitoring model.

20. The apparatus of claim 17, wherein adjusting the phase signal of the signal light of the unbalanced intersection is implemented based on a phase signal adjusting model, an input to the phase signal adjusting model comprises at least one of attribute information of the road intersection, the road traffic information, or a constraint condition, and an output from the phase signal adjusting model comprises a green time ratio of each phase signal of the signal light of the road intersection.

21. The apparatus of claim 17, wherein the one or more processors are configured to execute the set of instruction to cause the apparatus to further perform:
displaying at least one of the road condition monitoring result of the traffic network, a phase signal adjustment scheme for the signal light of the road intersection, or the road condition parameters of the traffic network.

22. The apparatus of claim 17, wherein at least one of monitoring the traffic road condition of the traffic network based on the generated road condition parameters or adjusting the phase signal of the signal light of the unbalanced intersection is implemented based on a cloud server cluster deployed in the cloud computing environment and implemented based on a cloud server node of the cloud server cluster,
storing the attribute information and the road traffic information of the traffic network comprises storing at least one of the attribute information, the road traffic information, or the road condition parameters of the traffic network based on a database service provided by the cloud server cluster, and
analyzing the attribute information and the road traffic information is implemented based on a cloud computing service provided by the cloud server cluster.

23. A non-transitory computer readable medium that stores a set of instructions that is executable by at least one processor of a computer to cause the computer to perform a method for analyzing a traffic road condition, the method comprising:
acquiring attribute information and road traffic information of a traffic network comprising road intersections and road segments;
analyzing the attribute information and the road traffic information to generate road condition parameters;
monitoring the traffic road condition of the traffic network based on the generated road condition parameters; and
adjusting, in response to a determination that a road condition monitoring result of a road intersection of the traffic network is an unbalanced intersection, a phase signal of a signal light of the unbalanced intersection.

24. The non-transitory computer readable medium of claim 23, wherein the set of instructions that are executable by the at least one processor of a computer to cause the computer to further perform:
storing the attribute information and the road traffic information of the traffic network; and
training a real-time road condition monitoring model based on the attribute information and the road traffic information;
wherein monitoring the traffic road condition of the traffic network based on the generated road condition parameters comprises monitoring the traffic road condition of the traffic network based on the real-time road condition monitoring model, an input to the real-time road condition monitoring model comprising the road condition parameters of the traffic network, and an output from the real-time road condition monitoring model comprising the road condition monitoring result of the traffic network.

25. The non-transitory computer readable medium of claim 24, wherein after storing the attribute information and the road traffic information of the traffic network, and before training the real-time road condition monitoring model based on the attribute information and the road traffic information, the set of instructions that are executable by the at least one processor of a computer to cause the computer to further perform:
removing noise data in at least one of the attribute information or the road traffic information;
segmenting at least one of the attribute information or the road traffic information in a time dimension; and
ranking data segments obtained from the segmenting, and selecting data corresponding to the data segments as benchmark data, the benchmark data being used as parameters of the real-time road condition monitoring model.

26. The non-transitory computer readable medium of claim 23, wherein adjusting the phase signal of the signal light of the unbalanced intersection is implemented based on a phase signal adjusting model, an input to the phase signal adjusting model comprises at least one of attribute information of the road intersection, the road traffic information, or a constraint condition, and an output from the phase signal adjusting model comprises a green time ratio of each phase signal of the signal light of the road intersection.

27. The non-transitory computer readable medium of claim 23, wherein the set of instructions that are executable by the at least one processor of a computer to cause the computer to further perform:
displaying at least one of the road condition monitoring result of the traffic network, a phase signal adjustment scheme for the signal light of the road intersection, or the road condition parameters of the traffic network.

28. The non-transitory computer readable medium of claim 23, wherein at least one of monitoring the traffic road condition of the traffic network based on the generated road condition parameters or adjusting the phase signal of the signal light of the unbalanced intersection is implemented based on a cloud server cluster deployed in the cloud computing environment and implemented based on a cloud server node of the cloud server cluster,
storing the attribute information and the road traffic information of the traffic network comprises storing at least one of the attribute information, the road traffic information, or the road condition parameters of the traffic network based on a database service provided by the cloud server cluster, and
analyzing the attribute information and the road traffic information is implemented based on a cloud computing service provided by the cloud server cluster.
